(19) United States
(12) Patent Application Publication
(10) Pub. No.: US 2013/0173852 A1
(43) Pub. Date: Jul. 4, 2013

(54) MEMORY SYSTEM

(71) Applicant: Hirokazu MORITA, Kanagawa (JP)

(72) Inventor: Hirokazu MORITA, Kanagawa (JP)

(73) Assignee: Kabushiki Kaisha Toshiba, Tokyo (JP)

(21) Appl. No.: 13/613,379

(22) Filed: Sep. 13, 2012

(30) Foreign Application Priority Data
Dec. 28, 2011 (JP) 2011-288699

(51) Int. Cl. G06F 13/00

(52) U.S. Cl. 711/103; 711/E12.001

(57) ABSTRACT

According to the embodiments, a memory system includes a plurality of memory chips, I/O signal lines, CE signal lines, and a control unit. The plurality of memory chips is divided to a plurality of first groups. The first plurality of memory chips for each first group is divided to a plurality of second groups. Each of the I/O signal lines is commonly connected to the memory chips for each first group. Each of the CE lines is commonly connected to the memory chips for each second group. The control unit specifies one of the second groups using the CE signal line, and transmits a reset command to one of the I/O signal lines which is connected to the specified second group, at activation. Each of the memory chips belonging to the specified second group executes reset processing at respective timings after receiving the reset command.

### CROSS-REFERENCE TO RELATED APPLICATIONS

This application is based upon and claims the benefit of priority from Japanese Patent Application No. 2011-288699, filed on Dec. 28, 2011; the entire contents of which are incorporated herein by reference.

### FIELD

Embodiments described herein relate generally to a memory system.

### BACKGROUND

In recent years, an SSD (Solid State Drive) equipped with memory chips including NAND memory cells captures more attention, as a memory system for use in computer systems. The SSD has advantages of high speed and lightweight over a magnetic disk unit. The SSD executes reset processing of each memory chip at the activation.

### BRIEF DESCRIPTION OF THE DRAWINGS

FIG. 1 is a block diagram illustrating a configuration example of an SSD in which a memory system of a first embodiment is applied;

FIG. 2 is a diagram for explaining a configuration example of a drive control circuit;

FIG. 3 is diagram for explaining the relation of connection between NAND controllers and memory packages;

FIG. 4 is a diagram illustrating transition timings of various signals when a reset process is executed;

FIG. 5 is a diagram for explaining a configuration of one memory chip;

FIG. 6 is a circuit diagram illustrating a configuration example of one block included in a memory cell array;

FIG. 7 is a diagram for explaining a consumption current which flows to a memory chip and another chip which share a CE signal;

FIG. 8 is a flowchart for explaining reset processing at the activation of an SSD, according to the first embodiment;

FIG. 9 is a flowchart for explaining reset processing at the activation of an SSD, according to a second embodiment;

FIG. 10 is a diagram for explaining another example of the relation of connection between NAND controllers and memory packages;

FIG. 11 is a perspective view illustrating an example of a personal computer equipped with an SSD, according to the first embodiment; and

FIG. 12 is a diagram illustrating an example of a system configuration of a personal computer equipped with the SSD.

### DETAILED DESCRIPTION

According to the embodiments, a memory system includes a plurality of memory chips, I/O signal lines, chip enable (CE) signal lines and a control unit. Each of the plurality of memory chips includes a non-volatile memory cell array. The plurality of memory chips is divided to a plurality of first groups for a first plurality of memory chips. The first plurality of memory chips for each first group is divided to a plurality of second groups for a second plurality of memory chips. Each of the I/O signal lines is commonly connected to the first plurality of memory chips for each first group. Each of the CE signal lines is commonly connected to the second plurality of memory chips for each second group. The control unit individually controls the first plurality of memory chips for each first group, using the I/O signal line and the CE signal line. The control unit specifies one of the second groups using the CE signal line, and transmits a reset command to one of the I/O signal lines which is connected to the specified second group, at activation. Each of the second plurality of memory chips belonging to the specified second group executes reset processing at respective timings after receiving the reset command.

Exemplary embodiments of the memory system will be explained below in detail with reference to the accompanying drawings. The present invention is not limited to the following embodiments.

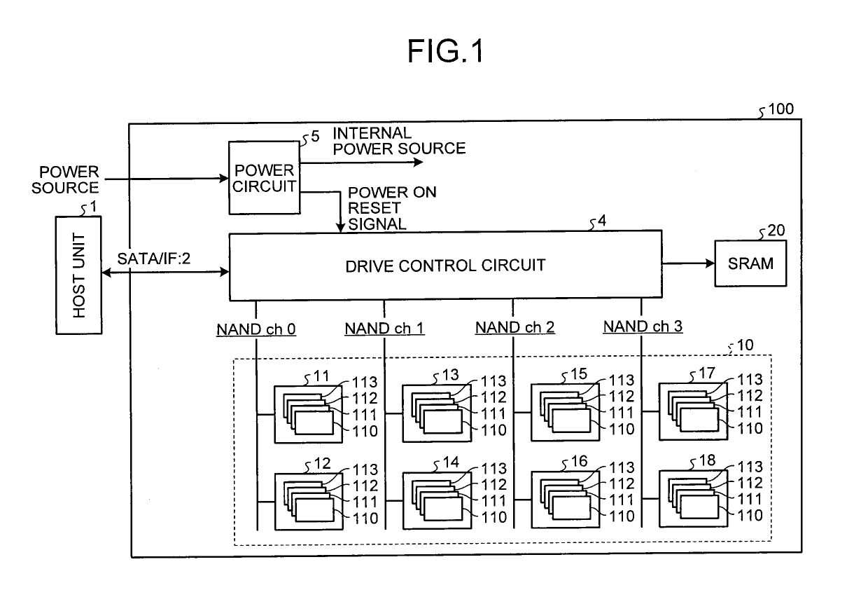

FIG. 1 is a block diagram illustrating a configuration example of an SSD 100 in which a memory system of a first embodiment is applied. The SSD 100 is connected to a host unit 1, such as a personal computer or a CPU core, via a memory connection interface, such as a SATA interface (SATA I/F) 2, and functions as an external memory of the host unit 1. The SSD 100 includes a NAND flash memory (hereinafter referred to as a NAND memory) 10 which is a nonvolatile semiconductor memory, a drive control circuit 4 as a control unit, an SRAM 20, and a power circuit 5.

The power circuit 5 generates a plurality of different internal direct current voltages from an external direct current power source supplied from the power circuit on the side of the host unit 1, and supplies these internal direct current voltages to each circuit inside the SSD 100. Upon detection of rising of an external power source at the activation of the SSD 100, the power circuit 5 generates a power ON reset signal. The power circuit 5 supplies the generated power ON reset signal to the drive control circuit 4.

The NAND memory 10 includes eight memory packages 11 to 18. Each of the eight memory packages 11 to 18 includes four memory chips 110 to 113 that are laminated. The drive control circuit 4 includes four groups of channel signals. Each pair of the eight memory packages 11 to 18 is connected to one channel. That is, the memory packages 11 and 12 are connected to the channel “0”, the memory packages 13 and 14 are connected to the channel “1”, the memory packages 15 and 16 are connected to the channel “2”, and the memory packages 17 and 18 are connected to the channel “3”. The drive control circuit 4 can control individually the memory chips belonging to their corresponding four channels, with the individualization of the four groups of channel signals. The four memory chips 110 to 113 are not necessarily laminated. The relation of connection between the memory packages 11 to 18 and the drive control circuit 4 will specifically be described later.

The SRAM 20 functions as a data transmission buffer between the host unit 1 and the NAND memory 10, and functions also as a working area memory. Any other memory unit may be used in place of the SRAM 20, if the memory unit provides faster access than the NAND memory 10. In place of the SRAM 20, a DRAM, a FeRAM, an MRAM, a ReRAM may be used.

The drive control unit 4 controls data transmission between the host unit 1 and the NAND memory 10 through the SRAM 20. Upon reception of a power ON reset signal from the power circuit 5, the drive control circuit 4 controls the above-described four groups of channel signals, to execute reset processing of the memory chips 110 to 113 included in the memory packages 11 to 18.

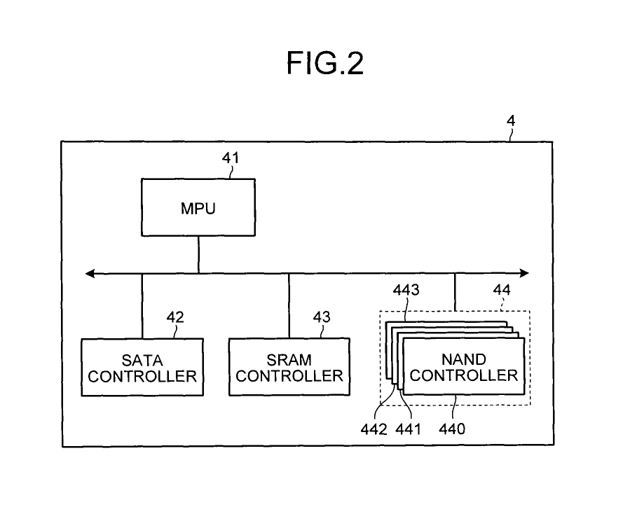

FIG. 2 is a diagram for explaining a configuration example of the drive control circuit 4. As illustrated, the drive control circuit 4 includes an MPU 41, an SATA controller 42, an SRAM controller 43, and four NAND controllers 440 to 443. The NAND controllers 440 to 443 may be collectively referred to as a NAND controller 44.

The MPU 41 entirely controls the drive control circuit 4 based on a firmware. The SATA controller 42 controls an SATA I/F 2, and executes data transmission between the host unit 1 and the SRAM 20, in response to an instruction from the MPU 41. The SRAM controller 43 executes read/write of data from/to the SRAM 20, in response to an instruction from the MPU 41. The NAND controller 44 executes reset processing for the memory chips 110 to 113 included in the memory packages 11 to 18 at the activation of the SSD 110, in response to an instruction from the MPU 41. After this, the NAND controller 44 executes data transmission between the NAND memory 10 and the SRAM 20.

Each of the eight memory packages 11 to 18 has four memory chips 110 to 113. Thus, the SSD 100 has thirty-two memory chips in total. When the reset processing is performed sequentially for these memory chips, it takes long time to activate the SSD 100. To reduce the activation time of the SSD 100, the SSD 100 of this embodiment of the present invention is configured to execute the reset processing simultaneously for the plurality of memory chips, instead of successively executing the reset processing for the memory chips.

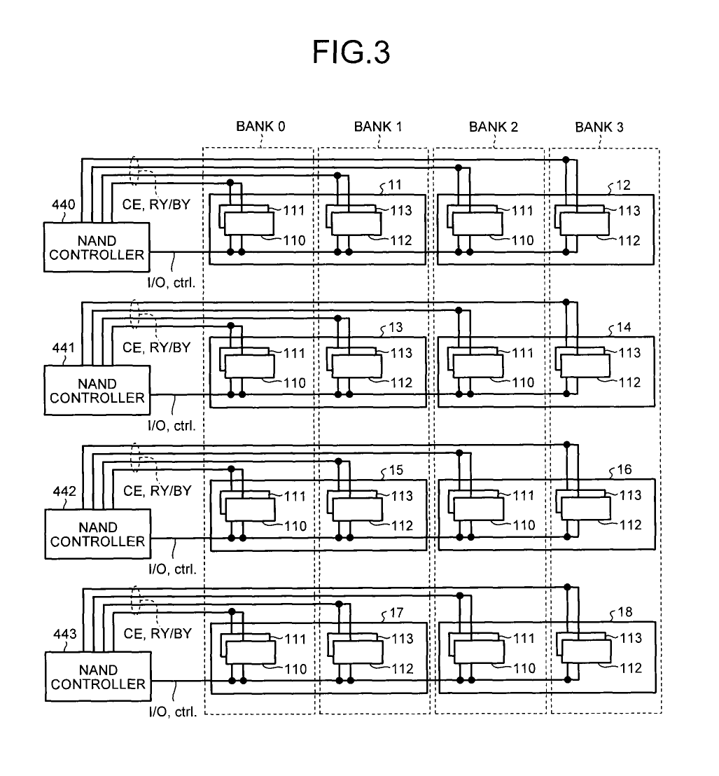

FIG. 3 is a diagram for explaining the relation of connection between the NAND controller 44 and the memory packages 11 to 18.

As illustrated, the eight memory chips belonging to each channel form a plurality of banks which enable bank interleave. Specifically, of the memory chips 110 to 113 included in the memory packages 11, 13, 15, and 17, the memory chips 110 and 111 form Bank “0”, while the memory chips 112 and 113 form Bank “1”. Of the memory chips 110 to 113 included in the memory packages 12, 14, 16, and 18, the memory chips 110 and 111 form Bank “2”, while the memory chips 112 and 113 form Bank “3”. The term “bank interleave” represents a technique for efficiently using the time by issuing a request for accessing a next bank, during a delay time of accessing data of a particular bank, that is, when an RY (Ready)/BY (Busy) signal of a particular bank is BY.

The relation of connection between the NAND controller 44 and the memory chips 110 to 113 is common between the channels. Descriptions will now be made to the relation of connection in channel “0” as a representative example. The group of signals forming the channel “0” includes a control signal (ctrl.), an I/O signal, a CE (Chip Enable) signal, and an RY/BY signal. The I/O signal is provided for transmitting/receiving data, address, and commands. The bit width of the I/O signal is not limited to one bit. The control signal is the general term for a WE (Write Enable) signal, an RE (Read Enable) signal, a CLE (Command Latch Enable) signal, an ALE (Address Latch Enable) signal, and a WP (Write Protect) signal. The CE signal is provided for the NAND controller 44 to specify a target memory chip for transmitting/receiving an I/O signal. The RY/BY signal indicates whether a chip memory is operating (busy) or not operating (ready).

The NAND controller 440 includes a control signal and an I/O signal. All the memory chips belonging to the memory packages 11 and 12 are commonly connected to this control signal and the I/O signal. In this illustration, for the sake of simplicity, the control signal and the I/O signal are illustrated in the same line. The NAND controller 440 includes four CE signals and four RY/BY signals. The memory chips 110 to 113 belonging to the memory packages 11 and 12 are connected to the CE signals and the RY/BY signals individually for each bank. The plurality of memory chips with the same bank number share the CE signals and the RY/BY signals therebetween. The CE signals and the RY/BY signals are illustrated in the same line, as well.

Accordingly, the plurality of memory chips 110 to 113 belong to either one of the plurality of (four in this example) channels, while the plurality of memory chips belonging to the same channel belong to either one of the plurality of banks formed of two or more memory chips. The plurality of memory chips belonging to the same channel is commonly connected to the I/O signals, while the memory chips belonging to the same bank is commonly connected to the CE signals.

The plurality of memory chips corresponding to an asserted CE signal latch a command transmitted as an I/O signal, and performs an operation in accordance with the latched command. When a command (with an address such as a data read request and a data write request) is transmitted, of the plurality of memory chips corresponding to the asserted CE signal, a memory chip specified with the address responds to this corresponding command. The command (reset command) for executing reset processing does not include an address. Thus, the plurality of memory chips sharing the CE signal respond to a transmitted reset command.

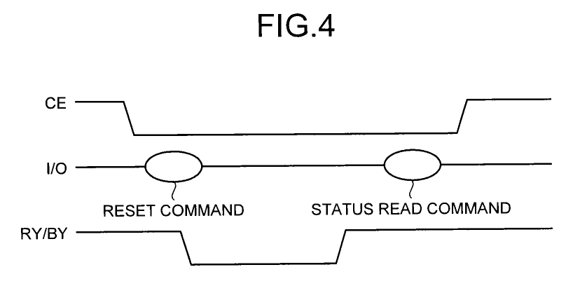

FIG. 4 is a diagram illustrating transition timings of various signals, when reset processing is executed. The statuses of a CE signal, an I/O signal, and an RY/BY signal are illustrated, sequentially from the upper row in the illustration. The CE signal is pulled up to a high voltage level, and asserted. As a result, a voltage level is transited from a high level to a low level (Low). The RY/BY signal is also pulled up, and a high voltage status indicates an RY status, while a low voltage status indicates a BY status. As illustrated, the NAND controller 440 asserts a CE signal connected to the memory chips of a target bank for reset processing, and transmits a reset command to as an I/O signal. The I/O signal is transmitted to all of the memory chips 110 to 113 belonging to the memory packages 11 and 12. Of the memory chips, two memory chips belonging to a bank corresponding to the asserted CE signal latch and take a reset command. The two memory chips which have taken the reset command start reset processing therein, and transits an RY/BY signal to BY. Upon completion of the reset processing, the two memory chips transit the RY/BY signal to the RY. However, the RY/BY signal is commonly connected to the two memory chips. Thus, if both of the memory chips complete the reset processing, the RY/BY signal is transited to the RY status. If the NAND controller 440 recognizes that the RY/BY signal is in the RY status, it transmits a status read command as an I/O signal. When the status read command is latched, the two memory chips send back status information through the I/O signal. The status information to be sent back represents whether the reset processing is normally ended.

Accordingly, the NAND controller 440 asserts a CE signal corresponding to a target bank to be accessed and uses the I/O signal, thereby executing reset processing simultaneously for the two memory chips belonging to the target bank to be accessed. In the first embodiment, the SSD 100 executes the reset processing in the entire channels, thereby simultaneously performing the reset processing of the memory chips belonging to the same bank of the entire channels.

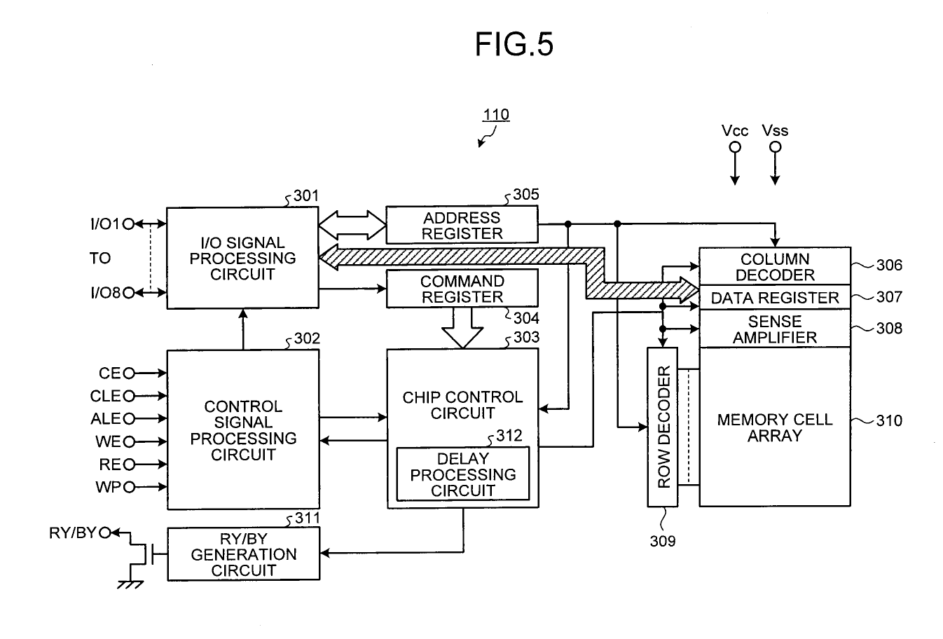

FIG. 5 is a diagram for explaining a configuration of one memory chip. The eight memory chips 110 to 117 have the same configuration. Thus, descriptions will now be made to the memory chip 110 as a representative.

As illustrated in FIG. 5, the memory chip 110 includes an I/O signal processing circuit 301, a control signal processing circuit 302, a chip control circuit 303, a command register 304, an address register 305, a column decoder 306, a data register 307, a sense amplifier 308, a row decoder 309, a memory cell array 310, and an RY/BY generation circuit 311.

The chip control circuit 303 is a status transition circuit which performs status transition for itself based on various control signals received through the control signal processing circuit 302, and controls the entire operation of the memory chip 110. The RY/BY generation circuit 311 transits the status of the RY/BY signal line between the ready status (RY) and the busy status (BY), under the control of the chip control circuit 303.

The I/O signal processing circuit 301 is a buffer circuit for transmitting/receiving an I/O signal to/from the NAND controller 44. A command latched by the I/O signal processing circuit 301, an address specifying the accessing destination, and data (to be written) are allocated to and stored in the address register 305, the command register 304, and the data register 307, respectively.

The address stored in the address register 305 includes a chip address for identifying the memory chip 110, a row address, and a column address, sequentially from the high order. The chip address is read by the chip control circuit 303, the row address is read by the row decoder 309, and the column address is read by the column decoder 306, respectively.

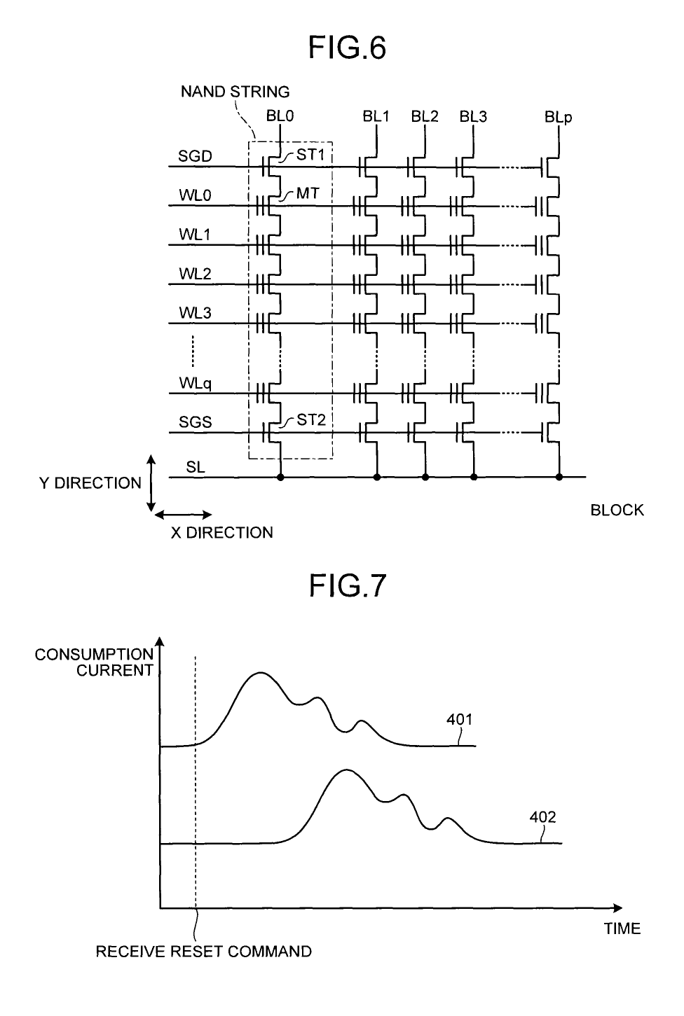

The memory cell array 310 is formed of a plurality of blocks in particular units for erasure. FIG. 6 is a circuit diagram illustrating a configuration example of one block included in the memory cell array 310. As illustrated, each block includes an (m+1) number (“m” is an integer greater than 0) of NAND strings that are aligned sequentially along an “X” direction. In each of the (m+1) number of NAND strings, a selection transistor ST1 has a drain connected to bit lines BL 0 to BLp and also a gate commonly connected to a gate line SGD. A selection transistor ST2 has a source commonly connected to a source line SL, and has a gate commonly connected to a gate line SGS.

Each memory cell transistor MT includes a MOSFET having a layered gate structure. The layered gate structure includes a charge storage layer (floating gate electrode) and a control gate electrode. The charge storage layer is formed on the semiconductor substrate via a gate insulating film, while the control gate electrode is formed on the charge storage layer via the gate insulating film. A threshold value of the memory cell transistor MT changes in accordance with the number of electrons stored in the floating gate electrode. The transistor MT stores data in accordance with the change of this threshold value. The memory cell transistor MT may be configured to store one bit, or may be configured to store multiple values (data of two or more bits).

In each NAND string, an (n+1) number of memory cell transistors MT are arranged so that their current paths are connected in series, between the source of the selection transistor ST1 and the drain of the selection transistor ST2. The control gate electrodes are connected to word lines WL0 to WLq, sequentially from the memory cell transistor MT nearest to the drain side. Thus, the drain of the memory cell transistor MT connected to the word line WL0 is connected to the source of the selection transistor ST1, while the source of the memory cell transistor MT connected to the word line WLq is connected to the drain of the selection transistor ST2.

The word lines WL0 to WLq are commonly connected to the control gate electrodes of the memory cell transistor between the NAND strings in the block. That is, the control gate electrodes of the memory cell transistors MT in the same row of the block are connected to the same word lines WL. An (m+1) number of memory cell transistors MT connected to the same word line WL are managed as one page, and data is written to and read from each page.

The row decoder 309, the column decoder 306, and the sense amplifier 308 access the memory cell array 310, under the control of the chip control circuit 303. Specifically, the row decoder 309 selects a word line corresponding to a read row address, and activates the selected word line. The column decoder 306 selects and activates a bit line corresponding to the read column address. The sense amplifier 308 applies a voltage to the bit line selected by the column decoder 306, and writes data stored in the data register 307 into a memory cell transistor which is positioned at the intersection of the word line selected by the row decoder 309 with the bit line selected by the column decoder. The sense amplifier 308 reads data stored in the corresponding memory cell transistor 307 through a bit line, and stores the read data to the data register 307. The data stored in the data register 307 is transmitted to the I/O signal processing circuit 301 through a data line, and is transmitted from the I/O signal processing circuit 301 to a data transmission unit 4.

The control signal processing circuit 302 receives input of various control signals, and allocates I/O signals received by the I/O signal processing circuit 301 to target registers for storage. The control signal processing circuit 302 transmits the received signal to the chip control circuit 303.

The memory chip 110 shares a CE signal with the memory chip 111, and thus is specified as a target chip for reset processing at the same timing as that for the memory chip 111. The reset processing includes a process for reading a set value of a write voltage to be applied to the bit line by the sense amplifier 308, from a predetermined memory unit (for example, the memory cell array 310 or a not-illustrated ROM). In this reading process, the consumption current of the memory chips 110 and 111 reaches a peak. In this first embodiment of the present invention, to avoid overlapping of the peaks of the consumption currents at the reset processing of the memory chips 110 and 111 sharing the CE line, the memory chips 110 and 111 include delay processing circuits 312 for causing respective different delays since transmission of a reset signal until the start of executing reset processing.

FIG. 7 is a diagram for explaining a consumption current flowing to the memory chips 110 and 111 which share the CE signal at reset processing. A curved line 401 represents a consumption current flowing to the memory chip 110, while a curved line 402 represents a consumption current flowing to the memory chip 111. As illustrated, in the memory chips 110 and 111, the peaks of their consumption currents are apart from each other. It is obvious that the consumption currents of the two memory chips 110 and 111 in total is reduced, as compared to a case in which both of the consumption currents reach a peak at the same time.

In the above descriptions, each of the memory chips 110 and 111 is assumed to have the delay processing circuit 312. However, each of the entire memory chips sharing the CE signal line does not necessarily include the delay processing circuit 312, as long as the plurality of memory chips sharing the CE signal line can start the reset processing at respective timings. That is, for the memory chips 110 and 111, either one of the memory chips 110 and 111 may include the delay processing circuit 312.

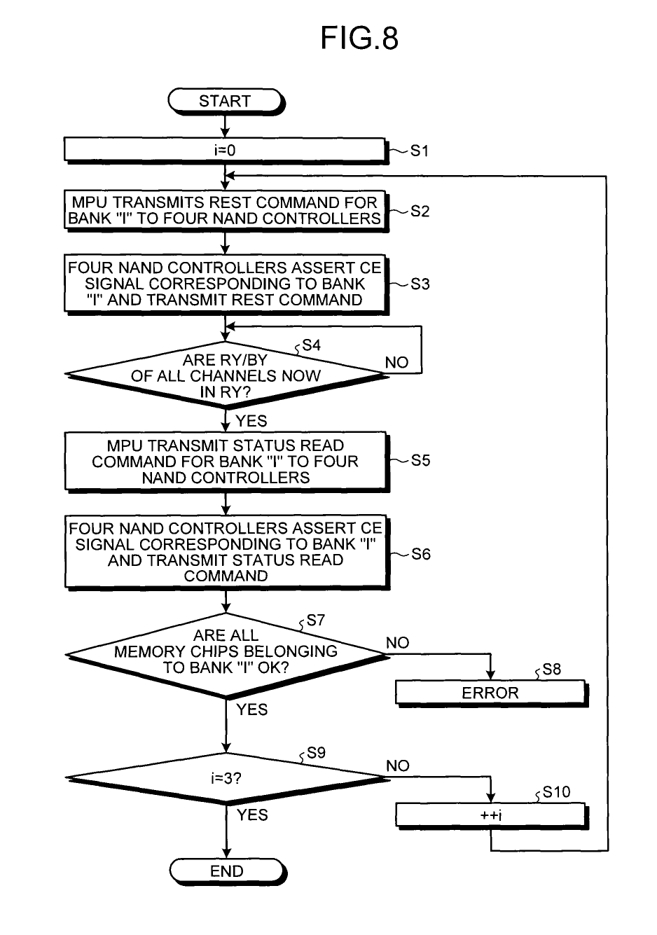

FIG. 8 is a flowchart for explaining reset processing at the activation of the SSD 100 according to the first embodiment. As illustrated, the MPU 41 initializes the loop index “i” with the value “0”, for a loop process as will be described later (Step S1). The MPU 41 transmits a reset command for Bank “i” to the four NAND controllers 440 to 443 (Step S2). The four controllers 440 to 443 assert the CE signal corresponding to the Bank “i”, and transmit a reset command as an I/O signal (Step S3).

Then, the total eight memory chips, belonging to the four channels corresponding to the connected and asserted CE signal, execute reset processing. In the execution of the reset processing, the RY/BY generation circuit 311 of the memory chips transits the RY/BY signal connected to the self memory chip to “BY”.

The MPU 41 determines whether the entire RY/BY signals corresponding to the Bank “i” of the entire channels are “RY” (Step S4). If there is a channel in which the RY/BY signals for the Bank “i” are “BY” (Step S4, No), the MPU 41 executes again a determination process of Step S4. If the “RY/BY” signals corresponding to the Bank “i” of the entire channels are “RY” (Step S4, Yes), the MPU 41 transmits a status read command for the Bank “i” to the four NAND controllers 440 to 443 (Step S5). Then, the four controllers 440 to 443 transmit a status read command as an I/O signal, while the CE signal corresponding to the Bank “i” is being asserted (Step S6).

After this, the MPU 41 checks status information of memory chips corresponding to the Bank “i” of the entire channels, and confirms whether the reset processing has securely been completed (Step S7). When the reset processing has not securely been completed (Step S7, No), the MPU 41 executes an error process (Step S8). This error process is not limited to a particular operation. When the reset processing of the memory chips corresponding to the Bank “i” of the entire channels has securely been completed (Step 7, Yes), the MPU 41 determines if “i=3” is satisfied (Step S9).

If “i=3” is not satisfied (Step S9, No), the MPU 41 increments “i” by 1(Step S10), and executes the process of Step S2. If “i=3” is satisfied (Step S9, Yes), the MPU 41 completes the reset processing at the activation.

As described above, according to the first embodiment, the plurality of memory chips 110 to 113 belong to either one of the plurality (four in this embodiment) of channels, and the plurality of memory chips belonging to the same channel belong to either one of a plurality of banks including two or more memory chips. The plurality of memory chips belonging to the same channel are commonly connected to the I/O signal, while the plurality of memory chips belonging to the same bank are commonly connected to the CE signal. The drive control circuit as a control unit specifies a bank using a CE signal line, and transmits a reset command to the I/O signal line corresponding to the channel belonging to the specified bank, at the activation. The plurality of memory chips belonging to the bank specified with the CE signal line receive the reset command, thereafter executing reset processing at different timings. According to this configuration, the reset processing at the activation of the plurality of memory chips can be simultaneously be executed. This realizes a reduction of the activation time, as compared with a case where the reset processing of the memory chips is executed sequentially one after another.

The drive control circuit 4 is configured to simultaneously execute the reset processing of the plurality of memory chips belonging to the same bank, of the plurality of memory chips belonging to the different channels, thus enabling to further reduce the activation time. After completing the reset processing of the plurality of memory chips belonging to one bank, the drive control circuit 4 executes the reset processing of the plurality of memory chips belonging to a next bank.

The SSD of the first embodiment executes the reset processing of the plurality of memory chips belonging to the same bank of the entire channels in parallel. An SSD of the second embodiment can execute the reset processing of the entire memory chips belonging to one single channel in parallel.

The configuration of the SSD of the second embodiment is the same as that of the first embodiment. The same constituent elements will be denoted using the same names and same reference numerals, and the same configuration parts of the SSD of the second embodiment will not repeatedly be described.

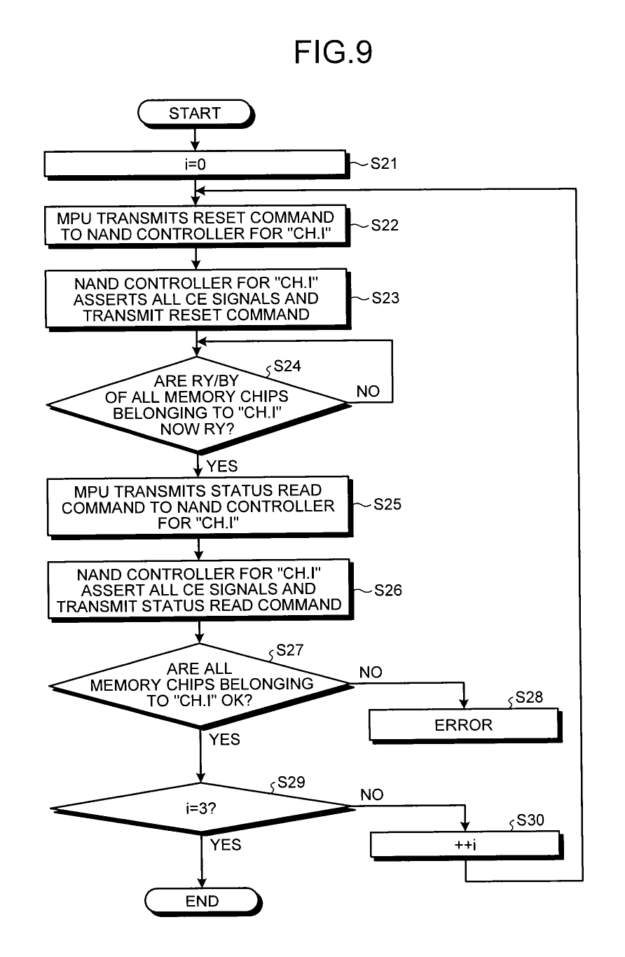

FIG. 9 is a flowchart for explaining reset processing at the activation of the SSD 100 of the second embodiment. As illustrated, the MPU 41 initializes the loop index “i” with the value “0” (Step S21). Of the NAND controllers 440 to 443, the MPU 41 transmits a reset command to the NAND controller 44 for the channel “i” (Step S22). Then, the NAND controller 44 for the channel “i” asserts the CE signals corresponding to the entire banks, and transmits a reset command as an I/O signal (Step S23).

Each of the total eight memory chips belonging to the channel “i” executes reset processing. During the execution of the reset processing, the RY/BY generation circuit 311 of each memory chip transits the RY/BY signal connected to the self memory chip to “BY”.

The MPU 41 determines whether the RY/BY signals corresponding to the entire banks of the channel “i” are “RY” (Step S24). If there is a bank in which the RY/BY signal is “BY” (Step S24, No), the MPU 41 executes the determination process of Step S24 again. The MPU 41 transmits a status read command to the NAND controller 44 for the channel “i” (Step S25). Then, the NAND controller 44 for the channel “i” transmits a status read command to the I/O signal line, while asserting the CE signals of the entire banks (Step S26).

After this, the MPU 41 checks the status information of the entire memory chips belonging to the channel “i”, and confirms whether the reset processing has securely been completed (Step S27). When the reset processing has not securely been completed (Step S27, No), the MPU 41 executes an error process (Step S28). If the reset processing of the entire memory chips belonging to the channel “i” has securely been completed (Step S27, Yes), the MPU 41 determines if “i=3” is satisfied (Step S29).

If “i=3” is not satisfied (Step S29, No), the MPU 41 increments “i” by 1 (Step S30), and executes the process of Step S22. If “i=3” is satisfied (Step S29, Yes), the MPU 41 completes the reset processing at the activation.

As describe above, according to the second embodiment of the present invention, the drive control circuit 4 is configured to specify the entire banks included in the same channel to execute the reset processing. Thus, like the first embodiment, the activation time of the SSD 100 can be reduced.

As described above, each of the memory packages 11 to 18 included in the SSD 100 of the first and second embodiments has four memory chips 110 to 113, each of which is controlled in accordance with one I/O signal and two CE signals. However, the relation of connection between the NAND controller and the memory chips is not limited to the above, as long as the plurality of memory chips share the I/O signals and the CE signals. In a third embodiment, descriptions will now be made to another example of the relation of connection between the NAND controllers and the memory chips. The same constituent elements as those of the first embodiment are denoted using the same names and reference numerals, and only different constituent elements will hereinafter be described.

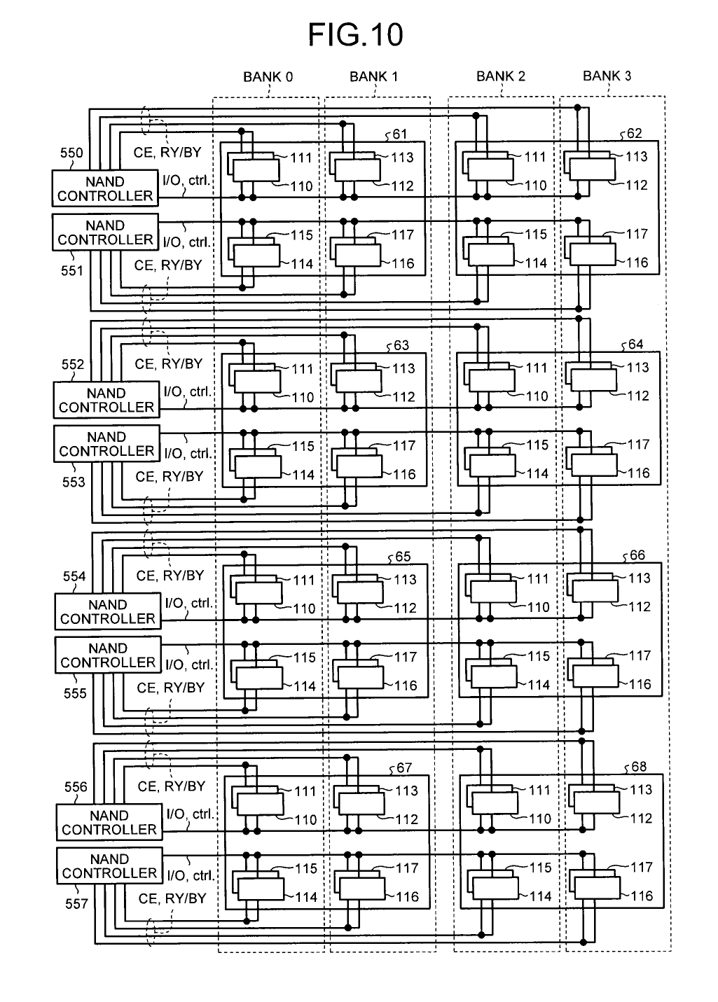

FIG. 10 is a diagram for explaining another example of the relation of connection between the NAND controllers and the memory packages. As illustrated, the SSD 100 of the third embodiment includes eight memory packages 61 to 68 and eight NAND controllers 550 to 557. Each of the eight NAND controllers 550 to 557 controls a group of signal lines corresponding to one channel. The eight NAND controllers 550 to 557 may be collectively referred to as a NAND controller 55.

Of the memory chips 110 to 117 included in the memory packages 61, 63, 65, and 67, the memory chips 110, 111, 114, and 115 form the Bank 0, while the memory chips 112, 113, 116, and 117 form the Bank 1. Of the memory chips 110 to 117 included in the memory packages 62, 64, 66, 68, the memory chips 110, 111, 114, and 115 form the Bank 2, while the memory chips 112, 113, 116, and 117 form the Bank 3.

Each of the memory packages 61 to 68 includes eight memory chips 110 to 117, and is controlled by two NAND controllers 55. Specifically, the NAND controllers 550 and 551 control the memory packages 61 and 62, the NAND controllers 552 and 553 control the memory packages 63 and 64, the NAND controllers 554 and 555 control the memory packages 65 and 66, and the NAND controllers 556 and 557 control the memory packages 67 and 68.

Descriptions will now be made with regard to the relation of connection between the memory chips 110 to 117 and the NAND controller 55. The memory packages 61 and 62 will now be described as representatives of the memory packages 61 to 68. Of the memory chips 110 to 117 included in the memory packages 61 to 62, the memory chips 110 to 113 are commonly connected to I/O signals and control signals included in the NAND controller 550, while the memory chips 114 to 117 are commonly connected to I/O signals and controls signals included in the NAND controller 551. The NAND controller 550 includes four CE signals and four RY/BY signals. The memory chips 110 to 113 belonging to the memory packages 61 and 62 are connected to the CE signals and RY/BY signals of the NAND controller 550, individually for each bank. Similarly, the NAND controller 551 includes four CE signals and four RY/BY signals. The memory chips 114 to 117 belonging to the memory packages 61 and 62 are connected to the CE signals and RY/BY signals of the NAND controller 551, individually for each bank.

Accordingly, the relation of connection between the memory chips 110 to 113 included in the memory packages 61 and 62 and the NAND controller 550 and the relation of connection between the memory chips 114 to 117 included in the memory packages 61 and 62 and the NAND controller 51 are the same as the relation of connection between the memory chips 110 to 113 included in the memory packages 11 and 12 and the NAND controller 440, described in the first embodiment. That is, the NAND controllers 550 and 551 assert the CE signal corresponding to the target bank to be accessed, and use the I/O signal, thereby simultaneously executing the reset processing of the two memory chips belonging to the target bank to be accessed.

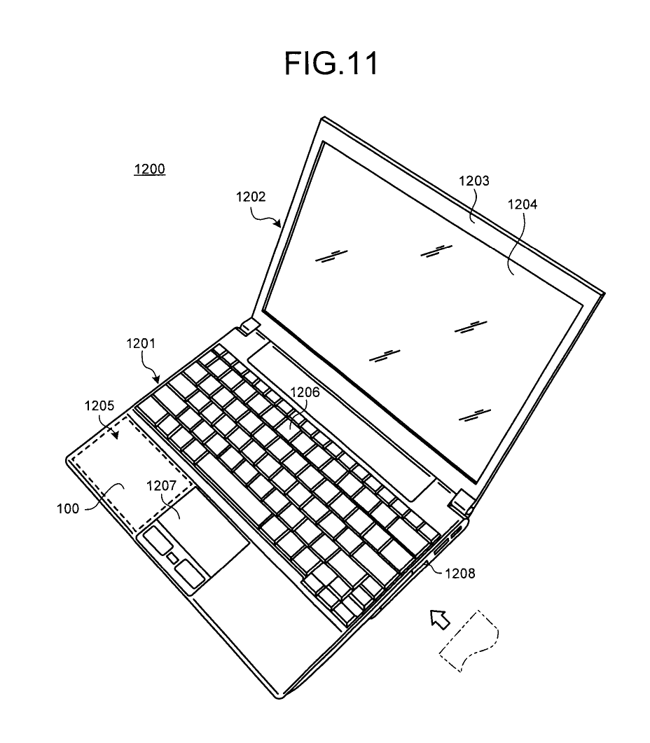

FIG. 11 is a perspective view illustrating an example of a personal computer 1200 equipped with the SSD 100 of the first embodiment. The personal computer 1200 includes a body 1201, and a display unit 1202. The display unit 1202 includes a display housing 1203 and a display device 1204 which is contained in this display housing 1203.

The body 1201 includes a case 1205, a keyboard 1206, and a touchpad 1207 as a pointing device. The case 1205 includes a main circuit substrate, an ODD (Optical Disk Device) unit, a card slot, the SSD 100, and the like thereinside.

The card slot is provided adjacent to the peripheral wall of the case 1205. An opening 1208 opposed to the card slot is provided on this peripheral wall. Additional devices can be inserted and pulled out into and from the card slot from outside of the case 1205 through this opening 1208.

The SSD 100 may be used in a state where it is installed inside the personal computer 1200, or may be used as an additional device in a state where it is inserted into the card slot included in the personal computer, in place of the conventional HDD.

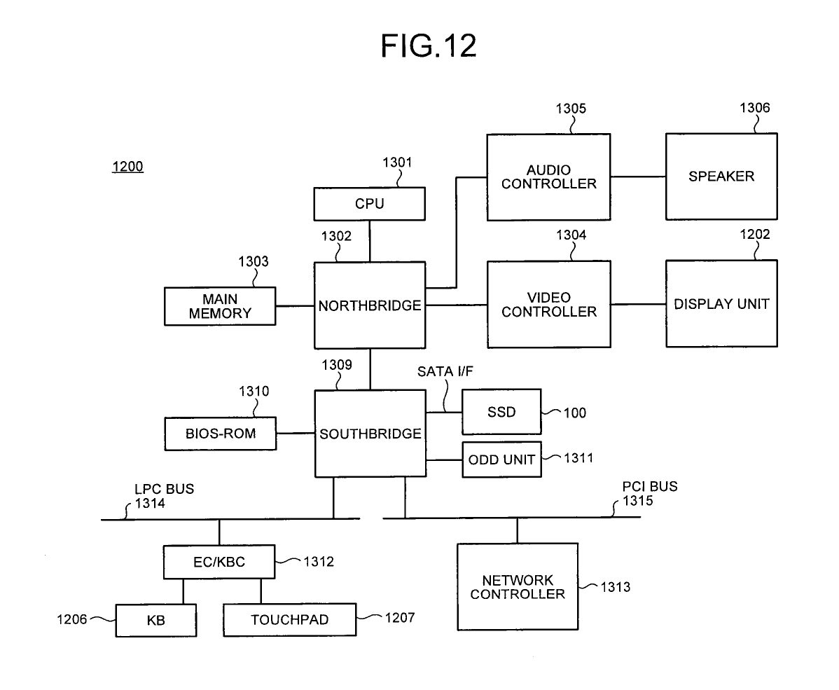

FIG. 12 illustrates an example of a system configuration of the personal computer equipped with the SSD. The personal computer 1200 includes a CPU 1301, a northbridge 1302, a main memory 1303, a video controller 1304, an audio controller 1305, a southbridge 1309, a BIOS-ROM 1310, the SSD 100, an ODD unit 1311, an embedded controller/keyboard controller IC (EC/KBC) 1312, and a network controller 1313.

The CPU 1301 is a processor provided for controlling the operations of the personal computer 1200, and executes the OS (Operating System) loaded from the SSD 100 into the main memory 1303. Further, if the ODD unit 1311 enables to execute at least one process of the reading process and the writing process from and to an installed optical disk, the CPU 130 executes these processes.

The CPU 1301 also executes the system BIOS (Basic Input Output System) stored in the BIOS-ROM 1301. The system BIOS is a program for controlling the hardware inside the personal computer 1200.

The northbridge 1302 is a bridge device for connecting the local bus of the CPU 1301 and the southbridge 1309. The northbridge 1302 has a memory controller which controls access to the main memory 1303.

The northbridge 1302 has a function for executing communication with the video controller 1304 through an AGP (Accelerated Graphics Port) bus and also communication with the audio controller 1305.

The main memory 1303 temporarily stores programs or data, and functions as a work area for the CPU 1301. The main memory 1303 includes, for example, RAM.

The video controller 1304 is a video playback controller which controls a speaker 1306 of the personal computer 1200.

The southbridge 1309 controls each device on an LPC (Low Pin Count) bus 1314 and each device on a PCI (Peripheral Component Interconnect) bus 1315. The southbridge 1309 controls the SSD 100 as a memory unit storing various software and data, through an SATA interface.

The personal computer 1200 accesses the SSD 100 in the unit of sectors. A write command, a read command, and a cache flush command are input into the SSD 100, through the SATA interface.

The southbridge 1309 has also a function for controlling access to the BIOS-ROM 1310, the ODD unit 1311.

The EC/KBC 1312 is a one-chip microcomputer in which an embedded controller for power management and a keyboard controller are integrated. The keyboard controller controls the keyboard (KB) 1206 and the touchpad 1207.

This EC/KBC 1312 has a function for turning ON/OFF power of the personal computer 1200, in accordance with the user operation of the power button. The network controller 1313 is a communication unit for executing communication with an external network, such as the Internet.

The SSD 100 that the personal computer 1200 is equipped with is configured to prevent a too long response time for a write command, as compared with a case wherein the execution of a command is suspended until the resources are completely arranged. This reduces a difference between execution times of commands, that is, this prevents bias of the command response time. Thus, it is possible to improve the user convenience for those who use the personal computer 1200.

The personal computer 1200 may be equipped with any of the SSDs 100 described in the second and third embodiments, and can attain the same effect as the case in which it is equipped with the SSD 100 of the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a plurality of memory chips each of which includes a non-volatile memory cell array, the plurality of memory chips being divided to a plurality of first groups for a first plurality of memory chips, and the first plurality of memory chips for each first group being divided to a plurality of second groups for a second plurality of memory chips;
I/O signal lines each of which is commonly connected to the first plurality of memory chips for each first group;
chip enable (CE) signal lines each of which is commonly connected to the second plurality of memory chips for each second group; and
a control unit which individually controls the first plurality of memory chips for each first group, using the I/O signal line and the CE signal line, wherein
the control unit specifies one of the second groups using the CE signal line, and transmits a reset command to one of the I/O signal lines which is connected to the specified second group, at activation, and
each of the second plurality of memory chips belonging to the specified second group executes reset processing at respective timings after receiving the reset command.

2. The memory system according to claim 1, wherein
the control unit specifies one of the second groups from each of the plurality of first groups respectively, and transmits a reset command simultaneously to each of the I/O signal lines.

3. The memory system according to claim 2, wherein
each of the second groups configures each of a plurality of banks;
the control unit drives the I/O signal lines in parallel and performs bank interleaving for the plurality of memory chips, and at activation, after completely performing reset processing of the plurality of memory chips belonging to one bank, specifies a plurality of memory chips belonging to a next bank, and transmits a reset command thereto.

4. The memory system according to claim 3, wherein
the control unit checks whether reset processing is completed by transmitting a status read command after transmitting the reset command.

5. The memory system according to claim 4, further comprising
a ready/busy (RY/BY) signal lines each of which is commonly connected to the second plurality of memory chips for each second group, and wherein:
each of the memory chips keeps the RY/BY signal line connected to itself BY state since the reset processing starts until the reset processing ends; and
the control unit transmits the status read command, after the reset command is transmitted and after the corresponding RY/BY signal line transits to RY state.

6. The memory system according to claim 1, wherein
the control unit specifies entire second groups included for each first groups simultaneously, and transmits a reset command thereto.

7. The memory system according to claim 6, wherein
the control unit checks whether the reset processing is completed by transmitting a status read command, after transmitting the reset command.

8. The memory system according to claim 7, further comprising
a ready/busy (RY/BY) signal lines each of which is commonly connected to the second plurality of memory chips for each second group, wherein
each of the memory chips keeps the RY/BY signal line connected to itself BY state since the reset processing starts until the reset processing ends; and
the control unit transmits the status read command, after the reset command is transmitted and after the corresponding RY/BY signal line transits to RY state.
